(19) United States
(12) Patent Application Publication
(10) Pub. No.: US 2017/0154227 A1
(43) Pub. Date: Jun. 1, 2017

(54) TRAFFIC SIGN RECOGNITION SYSTEM

(71) Applicant: Mazda Motor Corporation, Aki-gun (JP)

(72) Inventors: Takayuki Moritani, Hiroshima-shi (JP); Yasutaka Otsubo, Aki-gun (JP); Tsuyoshi Arinaga, Hiroshima-shi (JP)

(21) Appl. No.: 15/352,949

(22) Filed: Nov. 16, 2016

(30) Foreign Application Priority Data
Nov. 26, 2015 (JP) 2015-230220

(51) Int. Cl. G06K 9/00; G08G 1/0967

(52) U.S. Cl. CPC G06K 9/00818; G08G 1/0967

(57) ABSTRACT

A traffic sign recognition system is provided, which includes a display unit for displaying, for a driver of a vehicle, caution information regarding a traffic sign, and a processor configured to execute a specific traffic sign detecting module for detecting a specific traffic sign ahead of the vehicle, the specific traffic sign indicating that traveling of the vehicle in a given direction is allowed, and a vehicle behavior determining module for detecting a traveling direction of the vehicle. The processor controls the display unit to display caution information regarding the specific traffic sign when the detected traveling direction of the vehicle is different from the given direction, and controls the display unit not to display the caution information when the detected traveling direction of the vehicle matches with the given direction of the detected specific traffic sign.

### BACKGROUND

The present invention relates to a traffic sign recognition system.

In view of preventing danger etc., it is extremely undesirable to be unaware of traffic lights or a traffic sign placed on a road. JP2014-120111A discloses an art in which a detector for detecting a line of sight of a driver driving a vehicle is provided and if traffic lights and/or a traffic sign ahead of the vehicle is not viewed by the driver, caution information is displayed.

Although displaying the caution information when not being aware of the traffic sign etc. as disclosed in JP2014-120111A is suitable in view of preventing danger etc., it may, more often than not, be performed unnecessarily and become a cause of annoyance to the driver.

Incidentally, one example of the traffic sign is a sign for prohibiting vehicles from proceeding in directions other than a given direction (i.e., for only permitting vehicles to proceed in the given direction). For example, when a traffic sign illustrated with arrows pointing straight ahead and leftward is placed at a four-way junction ahead of a vehicle, this traffic sign means that proceeding straight ahead or making a left turn is permitted but making a right turn is prohibited. If the vehicle proceeds in a direction prohibited by this traffic sign, a dangerous situation which must be avoided, e.g., driving against traffic, occurs.

### SUMMARY

The present invention is made in view of the above problems and aims to provide a traffic sign recognition system which is capable of preventing a vehicle from proceeding in a prohibited direction while lowering a possibility of making a driver feel annoyed from being brought to attention.

According to one aspect of the present invention, a traffic sign recognition system is provided. The system includes a display unit for displaying, for a driver of a vehicle, caution information regarding a traffic sign, and a processor configured to execute a specific traffic sign detecting module for detecting a specific traffic sign ahead of the vehicle, the specific traffic sign indicating that traveling of the vehicle in a given direction is allowed, and a vehicle behavior determining module for detecting a traveling direction of the vehicle. The processor is configured to control the display unit in response to an output of the specific traffic sign detecting module by controlling the display unit to display caution information regarding the specific traffic sign when the detected traveling direction of the vehicle is different from the given direction, and controlling the display unit to refrain from displaying the caution information when the detected traveling direction of the vehicle matches with the given direction of the detected specific traffic sign.

According to the above configuration, when the vehicle is about to proceed in a prohibited direction, the caution information is displayed so as to prevent the vehicle from proceeding in the prohibited direction by mistake. Whereas, when the vehicle is about to proceed in the allowed direction, since it is not a problem, the caution information is not displayed regardless of whether the specific traffic sign is viewed by the driver. This is preferable in view of lowering a possibility of making the driver feel annoyed from displaying the caution information.

The system may further include an alarm device for issuing an alarm for the driver of the vehicle. The processor may be further configured to execute a viewing state detecting module for detecting whether the specific traffic sign is viewed by the driver of the vehicle. When the specific traffic sign is detected as not viewed by the driver in the case where the traveling direction of the vehicle is different from the given direction, the processor may control the display unit to display the caution information regarding the specific traffic sign and control the alarm device to issue the alarm. Here, when the vehicle is about to proceed in the prohibited direction and also the specific traffic sign is not viewed by the driver, the alarm is issued in addition to displaying the caution information so as to prevent the vehicle from proceeding in the prohibited direction by mistake.

When the specific traffic sign is detected as viewed by the driver in the case where the traveling direction of the vehicle is different from the given direction, the processor may control the display unit to display the caution information regarding the specific traffic sign without controlling the alarm device to issue the alarm. Here, even when the vehicle is about to proceed in the prohibited direction, if the specific traffic sign is viewed by the driver, it can be considered that there is a good reason for such traveling, and therefore, the alarm is not issued while displaying the caution information. This is preferable in view of lowering the possibility of making the driver feel annoyed from being alarmed.

When the specific traffic sign is detected as viewed by the driver in the case where the traveling direction of the vehicle is different from the given direction, the processor may control the display unit to refrain from displaying the caution information regarding the specific traffic sign and control the alarm device to refrain from issuing the alarm. Here, even when the vehicle is about to proceed in the prohibited direction, if the specific traffic sign is viewed by the driver, it can be considered that there is a good reason for such traveling, and therefore, the alarm is not issued and the caution information is not displayed. This is preferable in view of lowering the possibility of making the driver feel annoyed from issuing the alarm and displaying the caution information.

The vehicle behavior determining module may detect the traveling direction of the vehicle based on an operation status of a direction indicator. Since the direction indicator would be controlled before the driver selects the traveling direction, the above configuration is preferable in view of securing, when the vehicle proceed in the prohibited direction, enough time to bring to the attention of the driver.

### BRIEF DESCRIPTION OF THE DRAWINGS

FIG. 1 is a block diagram illustrating an example of a control system according to the present invention.

FIG. 2 is a view illustrating an example of a traffic sign which prohibits proceeding in directions other than a given direction.

FIG. 3 is a flowchart illustrating an example of a control according to the present invention.

### DETAILED DESCRIPTION OF EMBODIMENT

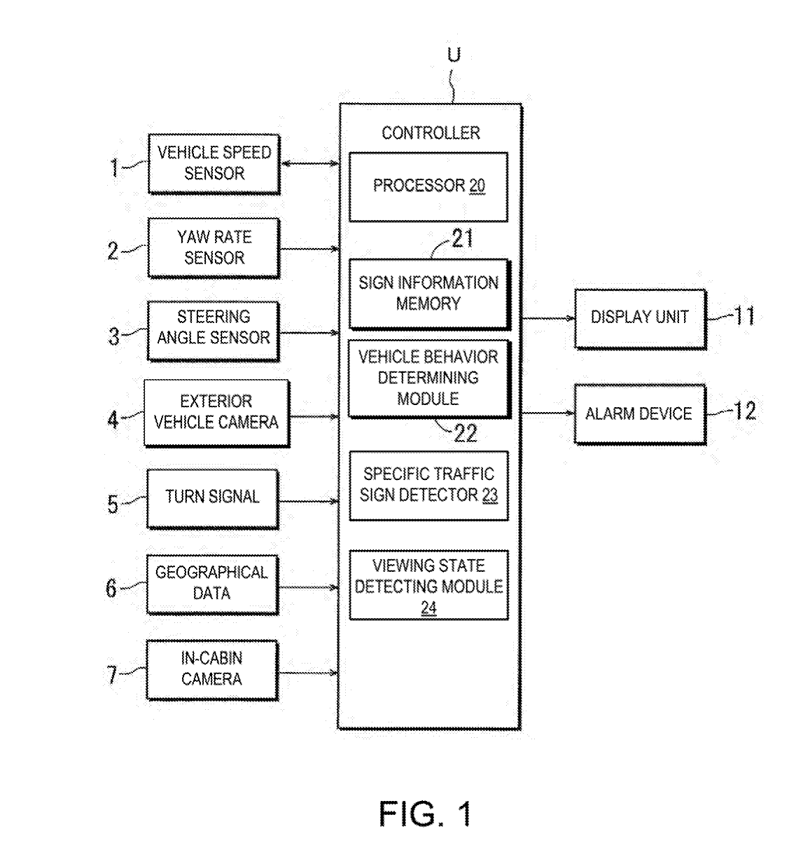

In FIG. 1, the reference character “U” is a controller (control unit) configured by using a microcomputer. The controller U receives signals from various sensors or devices 1 to 7. Specifically, the reference character “1” is a vehicle speed sensor for detecting a vehicle speed. The reference character “2” is a yaw rate sensor for detecting a yaw rate which applies to a vehicle concerned (hereinafter, simply referred to as “the vehicle”). The reference character “3” is a steering angle sensor for detecting a steering angle (including a steering direction). The reference character “4” is an exterior vehicle camera for imaging a view ahead of the vehicle, and it detects existence of a traffic sign ahead of the vehicle (especially a traffic sign for prohibiting vehicles to proceed in directions other than a given direction, in other words, a traffic sign indicating that traveling of vehicles to a given direction is permitted). The reference character “5” is a turn signal indicator (direction indicator) for detecting an intention of a driver of the vehicle for turning either right or left. The reference character “6” is a geographical data acquiring system (navigation system) for procuring information regarding the existence of traffic signs and a road condition ahead of the vehicle. The reference character “7” is an in-cabin camera for detecting a line of sight of the driver of the vehicle in order to detect whether the traffic sign ahead of the vehicle is viewed.

The controller U controls a display unit 11 and an alarm device 12 via a processor 20. When the vehicle proceeds (travels) in a direction different from the given direction of the traffic sign which prohibits vehicles to proceed in directions other than the given direction (hereinafter, referred to as “the only given direction permitted sign”), the display unit 11 displays caution information regarding this traffic sign. This display unit 11 may be configured by a display provided in front of a steering wheel or a head-up display. Further, the alarm device 12 may be a display type using a display separately provided from the display unit 11, voice guidance or a buzzer which issues an alarm sound, or a device using both of the alarm on display and the alarm by sound.

The controller U includes a sign information memory 21 for storing image data of various traffic signs and meanings thereof in association with each other (creating a database). Further, the controller U includes a vehicle behavior determining module 22 for determining, particularly, a traveling direction of the vehicle. Note that the traveling direction of the vehicle is determined, for example, based on one or a combination of any of an operation status of the turn signal indicator 5, the steering angle detected by the steering angle sensor 3, and the yaw rate detected by the yaw rate sensor 2. Further in this embodiment, a control according to the present invention is executed regardless of the magnitude of the vehicle speed; however, when the vehicle speed detected by the vehicle speed sensor 1 is zero (0) or substantially zero, it is considered that danger will not occur and the control may be not performed.

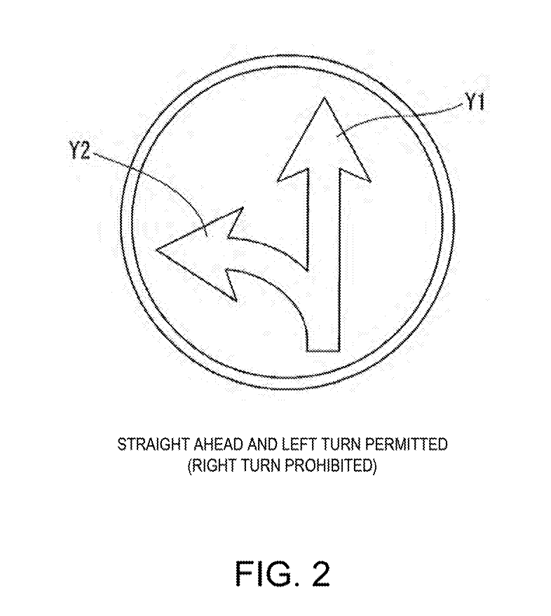

FIG. 2 is a view illustrating an example of the only given direction permitted sign. In the example of FIG. 2, a straight ahead arrow Y1 and a leftward arrow Y2 are displayed, which indicates that proceeding straight ahead or making a left turn is permitted, whereas proceeding in other directions therefrom is prohibited (e.g., a right turn is prohibited). Note that the only given direction permitted sign illustrated in FIG. 2 is merely an example, and other examples of the only given direction permitted sign include an only straight ahead permitted sign, an only left turn permitted sign, an only right turn permitted sign, and an only straight ahead or right turn permitted sign. Further, the number of given directions by the sign is not limited to two as illustrated in FIG. 2, and it may be one or three or more. For example, when a leftward arrow, an obliquely leftward arrow, and a straight ahead arrow are illustrated in the sign, making a right turn is prohibited.

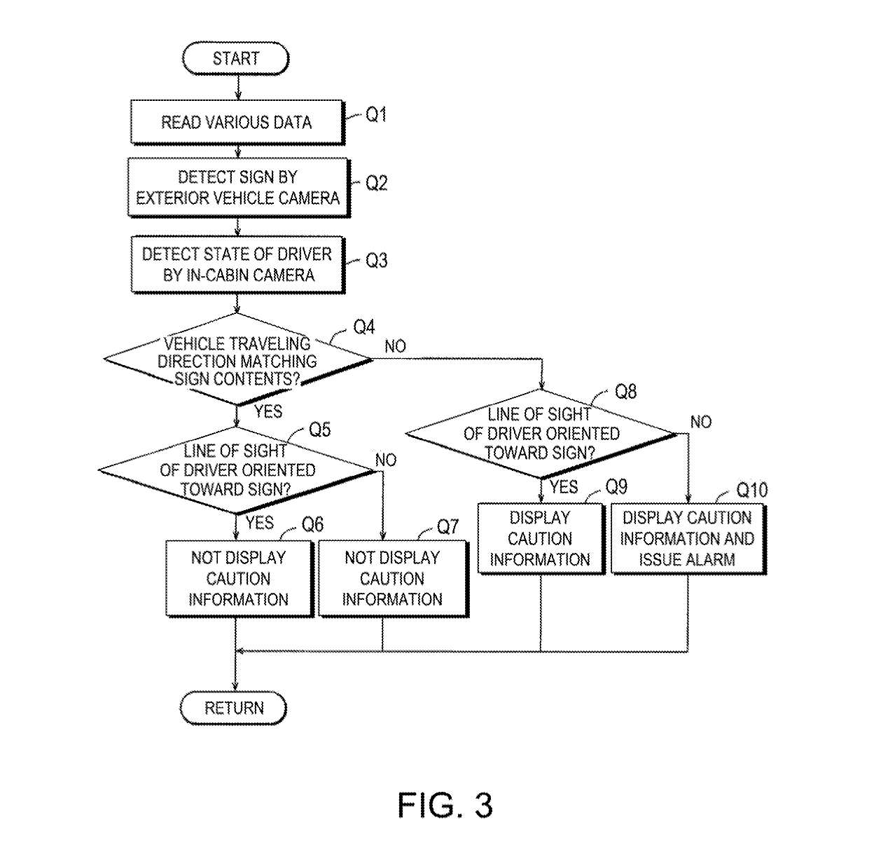

Next, an example of the control according to the present invention is described with reference to FIG. 3. Note that in the following description, “Q” indicates each process. First in Q1, the signals from the various sensors or the devices 1 to 7 are received. In Q2, the only given direction permitted sign stored in the sign information memory 21 of the controller U is detected from view(s) imaged by the exterior vehicle camera 4 (prohibited directions are determined). Then in Q3, the in-cabin camera 7 detects the line of sight of the driver.

Then in Q4, whether the traveling direction of the vehicle matches with the given direction by the only given direction permitted sign is determined. Specifically, the determination of Q4 is performed by determining whether the indicating direction of the turn signal indicator 5 corresponds to the direction permitted by the only given direction permitted sign.

If the determination result of Q4 is positive, in Q5, whether the line of sight of the driver is oriented toward the only given direction permitted sign is determined. Specifically, when the line of sight of the driver detected by the in-cabin camera 7 is oriented toward the only given direction permitted sign detected by the exterior vehicle camera 4, it is determined that the only given direction permitted sign is viewed by the driver. If the determination result of Q5 is positive, in Q6, the display unit 11 does not display the caution information regarding the only given direction permitted sign. Similarly, if the determination result of Q5 is negative, in Q7, the display unit 11 does not display the caution information regarding the only given direction permitted sign.

Note that when the determination result of Q4 is positive, although the processes of Q6 (or Q7) may be performed immediately, the processes of Q5 to Q7 are described in this embodiment in order to clarify the difference from JP2014-120111A. Specifically, in JP2014-120111A, if the determination result of Q5 is negative, the caution information is displayed in Q7. However, since it is already determined in Q4 that the vehicle proceeds to the direction permitted by the only given direction permitted sign, such caution information is only annoying to the driver, and therefore, the caution information is not displayed in this embodiment so as not to frustrate the driver.

If the determination result of Q4 is negative, in Q8, whether the line of sight of the driver is oriented toward the only given direction permitted sign is determined (whether the only given direction permitted sign is viewed). If the determination result of Q8 is positive, in Q9, the display unit 11 displays the caution information regarding the only given direction permitted sign. The display contents of the caution information may be, for example, if the vehicle is about to make a right turn while the right turn is prohibited, an illustration of “× mark on a rightward arrow” or letters “Right turn prohibited.” Note that caution information which is displayed corresponding to traffic signs is stored in the sign information memory 21 of the controller U, in association with the individual traffic signs.

If the determination result of Q8 is negative, this means that the vehicle proceeds in a direction prohibited by the only given direction permitted sign and the traffic signal is not viewed by the driver, which indicates that a level of carelessness of the driver is extremely high. In this case, in Q10, in addition to displaying on the display unit 11 the caution information as described above, the alarm device 12 is activated (issues an alarm). While this alarm may simply be an alarm sound by the buzzer, it preferably is an alarm by voice guidance, for example, issuing voice guidance “Right turn is prohibited” or “Stop turning right immediately.” Note that the alarm continues for a given period and then stops. This given period may be, for example, a given period of time such as 5 to 10 seconds, or a period until a vehicle operation for shifting away from the prohibited direction is detected.

Here, in order to reduce the annoyance to the driver caused by displaying the caution information, it may be such that if the determination result of Q8 is positive (the only given direction permitted sign is viewed by the driver), the display unit 11 does not display the caution information. Further the alarm device 12 may be omitted (if the determination result of Q8 is negative, the caution information may be displayed without issuing the alarm in Q10).

Although the embodiment is described above, the present invention is not limited to this, and may suitably be modified within the scope of the claims. The determination of the traveling direction of the vehicle based on which the caution information is displayed and/or the alarm is issued is preferably performed based on the operation status of the turn signal indicator. Specifically, since the turn signal indicator would be controlled before the steering wheel is controlled toward the prohibited direction, taking into consideration the operation status of the turn signal indicator is preferable in view of securing enough time to bring to the attention of the driver. Note that if the straight ahead direction is the prohibited direction, the vehicle is determined to be proceeding in the prohibited direction when the turn signal indicator is not controlled. Each one or a combination of two or more of the group of processes of the flowchart indicates a function of the controller U, and by adding “module” to the name/phrase indicating the function, it is possible to consider them as software components of the controller. For example, the controller U may comprise the vehicle behavior determining module 22 executable by the processor 20 to detect the traveling direction of the vehicle via at least one of the steering angle sensor 3, the turn signal 5, and the yaw rate sensor 2; a specific traffic sign detecting module 23 executable by the processor 20 to detect the specific traffic sign ahead of the vehicle via the external vehicle camera 4; and a viewing state detecting module 24 executable by the processor 20 to detect whether the specific traffic sign is viewed by the driver of the vehicle via the in-cabin camera 7. The purpose of the present invention is not limited to the explicitly described purpose, and also implicitly includes providing what is expressed as practically preferable or advantageous.

The present invention is preferable in preventing a vehicle from traveling in a prohibited direction.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### DESCRIPTION OF REFERENCE CHARACTERS

U Controller
3 Steering Angle Sensor
4 Exterior Vehicle Camera (For Traffic Sign Detection)
5 Turn Signal Indicator (For Proceeding Direction Detection)
7 In-cabin Camera (For Driver's Line of Sight Detection)
11 Display Unit
Alarm Device
21 Sign Information Memory
22 Vehicle Behavior Determining Module

What is claimed is:

1. A traffic sign recognition system, comprising:
a display unit for displaying, for a driver of a vehicle, caution information regarding a traffic sign; and
a processor configured to execute:
a specific traffic sign detecting module for detecting a specific traffic sign ahead of the vehicle, the specific traffic sign indicating that traveling of the vehicle in a given direction is allowed; and
a vehicle behavior determining module for detecting a traveling direction of the vehicle; wherein
the processor is configured to control the display unit in response to an output of the specific traffic sign detecting module by controlling the display unit to display caution information regarding the specific traffic sign when the detected traveling direction of the vehicle is different from the given direction, and controlling the display unit to refrain from displaying the caution information when the detected traveling direction of the vehicle matches with the given direction of the detected specific traffic sign.

2. The system of claim 1, further comprising:
an alarm device for issuing an alarm for the driver of the vehicle,
wherein the processor is further configured to execute a viewing state detecting module for detecting whether the specific traffic sign is viewed by the driver of the vehicle, and
wherein when the specific traffic sign is detected as not viewed by the driver in the case where the traveling direction of the vehicle is different from the given direction, the processor controls the display unit to display the caution information regarding the specific traffic sign and controls the alarm device to issue the alarm.

3. The system of claim 2, wherein when the specific traffic sign is detected as viewed by the driver in the case where the traveling direction of the vehicle is different from the given direction, the processor controls the display unit to display the caution information regarding the specific traffic sign without controlling the alarm device to issue the alarm.

4. The system of claim 2, wherein when the specific traffic sign is detected as viewed by the driver in the case where the traveling direction of the vehicle is different from the given direction, the processor controls the display unit to refrain from displaying the caution information regarding the specific traffic sign and controls the alarm device to refrain from issuing the alarm.

5. The system of claim 1, wherein the vehicle behavior determining module detects the traveling direction of the vehicle based on an operation status of a direction indicator.
